(19) United States
(12) Patent Application Publication
(10) Pub. No.: US 2023/0405819 A1
(43) Pub. Date: Dec. 21, 2023

(54) A ROBOT CONTROLLER WITH INTEGRATED LOGIC FUNCTIONALITY

(71) Applicant: Universal Robots A/S, Odense S. (DK)

(72) Inventors: Ievgen KRAVCHENKO, Odense C (DK); Kasper TOFTE, Odense M (DK)

(73) Assignee: Universal Robots A/S, Odense S. (DK)

(21) Appl. No.: 18/035,553

(22) PCT Filed: Nov. 5, 2021
(86) PCT No.: PCT/DK2021/050326

§ 371 Date: May 5, 2023

(30) Foreign Application Priority Data
Nov. 6, 2020 (DK) PA 2020 70736

(51) Int. Cl. B25J 9/16; B25J 13/06; B25J 9/00; B25J 19/02

(52) U.S. Cl. CPC B25J 9/1671; B25J 13/06; B25J 9/161; B25J 9/0093; B25J 9/1682; B25J 19/023

(57) ABSTRACT

The invention relates to a robot system comprising: a robot arm, a robot controller configured to execute a robot control In process based on a robot control software program and an auxiliary control process based on an auxiliary control software program; and a peripheral device communicatively connected to the 5 robot controller. Execution of the robot control process is performed by the robot controller resulting in operation of the robot arm. Execution of the auxiliary control process is performed by the robot controller resulting in establishing of a logic signal based on an application input signal received from the robot control process or the peripheral device. The auxiliary control process is configured to 10 establish a logic output signal based on the logic signal and, based on the logic output signal, configured to control operation of any of the robot control process and the peripheral device.

### FIELD OF THE INVENTION

The present invention relates to a robot arm comprising a plurality of robot joints connecting a robot base and a robot tool flange, where a robot controller is configured to control the robot arm in a robot application. Additionally, the present invention relates to a method for controlling the robot arm in a robot application.

### BACKGROUND OF THE INVENTION

Robot arms comprising a plurality of robot joints and links where motors can move part of the robot arm in relation to each other are known in the field of robotics. Typically, the robot arm comprises a robot base which serves as a mounting base for the robot arm; and a robot tool flange where to various tools can be attached. A robot controller is configured to control the robot joints in order to move the robot tool flange in relation to the base. For instance, in order to instruct the robot arm to carry out a number of working instructions. The robot joints may be rotational robot joints configured to rotate parts of the robot arm in relation to each other, prismatic joints configured to translate parts of the robot arm in relation to each other and/or any other kind of robot joints configured to move parts of the robot arm in relation to each other.

Typically, the robot controller is configured to control the robot joints based on a dynamic model of the robot arm, where the dynamic model defines a relationship between the forces acting on the robot arm and the resulting accelerations of the robot arm. Often, the dynamic model comprises a kinematic model of the robot arm, knowledge about inertia of the robot arm and other parameters influencing the movements of the robot arm. The kinematic model defines a relationship between the different parts of the robot arm and may comprise information of the robot arm such as, length, size of the joints and links and can for instance be described by Denavit-Hartenberg parameters or like. The dynamic model makes it possible for the controller to determine which torques the joint motors shall provide in order to move the robot joints for instance at specified velocity, acceleration or in order to hold the robot arm in a static posture.

Typically, it is possible to attach various end effectors to the robot tool flange or other parts of the robot arm, such as grippers, vacuum grippers, magnetic grippers, screwing machines, welding equipment, dispensing systems, visual systems etc.

Robot arms need to be programmed by a user or a robot integrator which defines various instructions for the robot arm, such as predefined moving patterns and working instructions such as gripping, waiting, releasing, screwing instructions. The instruction can be based on various sensors or input signals which typically provide a triggering signal used to stop or start a given instruction. The triggering signals can be provided by various indicators, such as safety curtains, vision systems, position indicators, etc.

Installing a robot in a robot application in which it interacts with various other equipment such as peripheral devices can be a complicated and time-consuming task. Interactions between the robot arm and its robot application is typically facilitated by external circuitry such as programmable logic circuits, which requires a certain level of expertise to install. This threshold of expertise restricts small and medium-sized facilities from integrating robots in their production, which could otherwise improve production efficiency and spare personnel from performing dangerous, unhealthy, or heavy-duty tasks.

Further, programming and reprogramming of robot systems can be a cumbersome process. Particularly, optimization and troubleshooting can be problematic, since it is not straightforward to predict how a robot arm interacts with its robot application.

The application US 2014/0214203 A1 discloses an operating program writing system comprising a block storing part which stores a plurality of blocks constituting work units of an operating program, a selecting part which selects any number of blocks from the plurality of blocks, a displaying part which displays a path diagram which is comprised of the any number of blocks and arguments which are contained in the blocks, a selecting and inputting part which selects at least one block among the any number of blocks and inputs the arguments of the at least one block, a running part which arranges run buttons for the respective any number of blocks and runs blocks which correspond to the run buttons, and a writing part which uses the any number of blocks and the input argument of the at least one block as the basis to write an operating program.

### SUMMARY OF THE INVENTION

The object of the present invention is to address the above described limitations with the prior art or other problems of the prior art. This is achieved by the method and robot system according to the independent claims where the dependent claims describe possible embodiments of the robot and methods according to the present invention. The advantages and benefits of the present invention are described in the detailed description of the invention.

An aspect of the invention relates to a robot system, comprising:
a robot arm comprising a plurality of robot joints connecting a robot base to a robot tool flange,
a robot controller configured to execute:
   a robot control process based on a robot control software program; and
   an auxiliary control process based on an auxiliary control software program; and
one or more peripheral devices communicatively connected to said robot controller,
   wherein execution of said robot control process performed by said robot controller results in operation of said robot arm,
   wherein execution of said auxiliary control process performed by said robot controller results in establishing of one or more logic signals based on at least one application input signal received from any of said robot control process and said one or more peripheral devices, and
   wherein said auxiliary control process is configured to establish at least one logic output signal based on said one or more logic signals and, based on said at least one logic output signal, configured to control operation of any of said robot control process and said one or more peripheral devices.

According to an embodiment of the invention, said operation of said robot arm is based on said at least one logic output signal.

According to an embodiment of the invention, controlling one of said one or more peripheral devices is based on said at least one logic output signal.

According to an embodiment of the invention, said at least one application input signal is received from said robot control process.

According to an embodiment of the invention, said at least one application input signal is received from said one or more peripheral devices.

The invention is advantageous in that it has the effect, that it allows a robot controller to directly control one or more peripheral devices without intermediate auxiliary circuitry between the robot controller and the peripheral devices, for example a PLC (PLC; Programmable Logic Circuit), responsible for signal processing, facilitation of communication, and logic operations. Furthermore, the invention is advantageous in that it allows control of the robot to be based on input from one or more peripheral devices without intermediate auxiliary circuitry between the robot controller and the peripheral devices.

Typically, such auxiliary circuitry requires extensive expertise, can be costly, may take up a substantial amount of physical volume, and may be time consuming to install. All this can be avoided when controlling a robot arm according to the present invention.

An advantage of the invention is thus that it allows a robot arm to be installed in a robot application or robot system with a reduced level of required expertise, for example since PLCs do not need to be installed and programmed.

A further advantage of the invention is that it allows a more rapid installation of a robot in a robot application since PLCs do not need to be programmed.

A further advantage of the invention is that it reduces the physical volume required to install a robot in a robot application, since no auxiliary circuitry is required.

A further advantage of the invention is that it may reduce costs for installing a robot in a robot application.

A further advantage of the invention is that communication speed between the robot and any peripheral devices is increased, since reduced intermediate signal processing is required.

A further advantage of the invention, is that since only one controller is necessary for controlling the robot arm and any peripheral devices according to the present invention, it allows easy and rapid reprogramming of the auxiliary and robot control process and thereby change or adjustment of the operation of the robot arm and its interaction with peripheral devices. This is because only one controller has to be accessed in that no auxiliary controller exists in the robot system according to the present invention.

A further advantage of the invention is that users may not need to learn using different programming environments as both the robot programming and auxiliary programming can be made in the same programming environment.

A further advantage of the invention is that users may only need to acquire one piece of equipment i.e. one robot arm having a controller capable of controlling peripheric devices. Hence, industrial PLCs and similar equipment is superfluous.

A further advantage of the invention is that running robot control process and an auxiliary control process separately (yet still by the same robot controller) makes it possible to ensure that the auxiliary control process controlling peripheral devices can continue to be executed in the event that the robot control process is interrupted for instance due to a protective and/or safety stop of the robot arm. For instance, if the auxiliary control process controls warning devices such as a light tower indicating the state of the robot arm.

Conventionally, peripheral devices are controlled using, e.g., a PLC. Further, conventionally, input may have been provided manually to a robot controller during programming of the robot controller. In contrast to conventional robot systems and methods, the invention may advantageously permit performance of multiple tasks (controlling the robot and directly communicating with peripheral devices) by the robot controller in an operational scenario.

A robot arm may be understood as a type of mechanical arm. It may typically have a number of robot joins and links where motors can move part of the arm in relation to another part of the arm. A robot arm may be controllable, e.g. by a programmable robot controller.

Robot controller should be understood as the controller controlling the operation of the robot arm.

A robot arm may be part of a robot system. A robot system may for example comprise the robot arm as well as its robot controller. A robot system may further comprise additional elements, such as peripheral devices.

Generally, a peripheral device may be understood as an external device which facilitates communication between the robot and its robot application, typically based on inputs and/or outputs. Examples include cameras, sensors, conveyer belts, indicative lights or similar. Note, however, that the invention is not limited to any particular device but may involve any peripheral device which is suitable. In one embodiment a peripheral device may also be another robot arm.

A robot application may be understood as a robot arm/robot system which is installed and programmed to perform a certain task, e.g. an industrial task, e.g. a task related to industrial production. A robot application often requires communication between the robot controller and peripheral devices. A robot application may also rely on a plurality of robot arms, which perform tasks along a production line.

A robot control process and an auxiliary control process may each be understood as individual processes conducted by software programs and executable by a single robot controller, e.g. a single processer/processing unit. Such processing unit may have a number of cores dedicated to execution of the robot control process and a number of separate cores dedicated to execution of the auxiliary control process.

A robot control software program may be understood as software, which is used by the robot controller, particularly as basis for executing a robot control process, to control movement of the robot arm i.e. of the individual joints and thereby, for example, position and angle of the robot tool flange. It may further control any robot tool attached to the robot tool flange.

An auxiliary control software program may be understood as software, which is used by the robot controller, particularly as basis for executing an auxiliary control process, to facilitate communication between the robot control process and one or more peripheral devices and to control the one or more peripheral devices. The robot control process may be provided as sequential logic implemented based on a finite state machine in a non-concurrent environment, tending to preserve the deterministic property of a program.

The robot and auxiliary control software programs may for example be based on corresponding robot and auxiliary control software codes, which have been compiled on a programming device to establish the programs which are readable by the robot controller.

An application input signal may be understood as digital and/or analogue signals provided from peripheral devices and/or the robot control process to the auxiliary control process. Any application input signals may be wired or wireless.

Logic signals and logic output signals may typically be understood as binary signals (high or low, “1” or “0”), for example represented by electric current, electric voltage, polarization of a field, magnetization of a magnetic storage media etc. Note, however, that the invention is not limited to binary signals or the above examples of representations. When operation of the robot control process is based on a logic signal, that logic signal may be considered an input to the robot control process or an input to the robot control software program. Similarly, when operation of a peripheral device is based on a logic signal, that logic signal may be considered an input to that peripheral device.

According to an embodiment of the invention, said robot control process and said auxiliary control process are arranged to be parallelly executed by said robot controller.

Executing the robot control process and the auxiliary control process in parallel i.e. simultaneously e.g. by different cores of a processing unit is advantageous since it reduces latency between the robot and its robot application, in turn reducing risk of errors and increasing the working pace. In contrast, relying on a robot control process and an auxiliary control process which is not executed in parallel may be slower and/or more prone to errors.

Embodiments where the robot control process and the auxiliary control process are executed in parallel/simultaneously are separate from examples in which an auxiliary control process is executed (and potentially finished) prior to execution of the robot control process. Such examples of separate execution may for example take place if an auxiliary control process is executed during programming of the robot system.

The robot control process and the auxiliary control process may be arranged to be parallelly executed by the robot controller while regulating any of operation of the robot arm and establishing of the one or more logic signals with respect to timings of any of the application input signal and the logic output signal which are communicated between the robot control process and the auxiliary control process. Thus, the parallel execution may advantageously maintain coordination between the execution of the robot control process and the execution of the auxiliary control process.

According to an embodiment the auxiliary control process is executed as a continuously running process where the auxiliary control process is configured to establish the at least one logic output signal within a program cycle where the auxiliary control process is executed independently of the state of the at least one application input signal.

This is advantageously in that the auxiliary control process can be configured to run continuously without waiting for input signals to update ensuring that all the logic functions of the auxiliary control processes are executed within the timing of the program cycle. Consequently, the one or more logic output signals are generated in each program cycle and if the auxiliary control process is executed at regular time intervals it can be ensured that the logic output signals are generated at regular intervals. It is to be understood that the state of the at least one logic output signal may depend on the state of the at least one application input signal. In other words, the auxiliary control process will generate the logic output signals in each program cycle independently of whether or not the at least one application input signals have changed during the program cycle.

According to an embodiment the auxiliary control process is configured to execute a plurality of sub-processes where each of the sub-processes is configured to establish at least one of the logics output signals.

This is advantageously in that different logic output signals can be generated independently of each other and also based on different application input signals. Further in connection with debugging the auxiliary control process, the programmer only needs to debug sub-processes which does not perform as intended.

According to an embodiment the auxiliary control process is configured to execute the sub-processes concurrently.

This is advantageously in that the logic output signals can be generated in parallel whereby the program cycle time of the auxiliary control process can be reduced which ensures faster update of the logic output signals.

According to an embodiment of the invention, said robot controller comprises a multi-core processor and said robot control process and said auxiliary control process are respectively executed on separate cores of said multi-core processor.

Utilizing a multi-core processor for implementation of a robot controller according to the invention is advantageous, since it facilitates parallel execution of processes on separate cores.

According to an embodiment of the invention, each of said one or more logic signals are individually indicative of a state of any of said one or more peripheral devices and said robot control process.

Using the one or more logic signals as indications of states of peripheral devices and/or the robot control process is advantageous since it allows logic operations and control to be performed based on these states without requiring programming of and communication though external circuitry such as PLCs.

According to an embodiment of the invention, one of said at least one logic output signal is one of said one or more logic signals.

According to an embodiment of the invention, said at least one logic output signal is said one or more logic signals.

Using one or more logic signals as logic output signals is advantageous, since these signals may typically be indicative of a state of any of the peripheral devices and the robot control process, and may thus be useful as basis for further operation of any of the peripheral devices and the robot control process.

According to an embodiment of the invention, one of said at least one logic output signal is based on logical operations applied to said one or more logic signals.

Logic operations may for example include basic AND, OR, and NOT operations. They may further be based on changes of the logic signals, such as rising and falling edges of logic signals, e.g. a logic output signal may change based on a rising/falling edge of a logic signal.

Basing at least one logic output signal on logical operations is advantageous, since it allows a simple and comprehendible relationship between the logic signals and the logic output signals. Further, logical operations it is a processing procedure which requires minimal computation power, which is also advantageous.

According to an embodiment of the invention, one of said one or more logic signals is one of said at least one application input signals.

It is advantageous to use one or more application input signals directly as logic signals, since it reduces the need for auxiliary circuitry and reduces latency.

According to an embodiment of the invention, a robot tool attached to said robot tool flange is operated based on said at least one logic output signal.

According to an embodiment of the invention, said operation of said robot arm comprises said robot arm applying said robot tool to an application object.

Operating the robot tool based on at least one logic output signal is advantageous, since it allows the robot tool to be operated in synchronization with the robot arm and peripheral devices.

Operating the robot tool may for example be understood as rotating a drill of the robot tool, gripping with a gripper of the robot tool, welding using the robot tool, cutting using the robot tool etc.

According to an embodiment of the invention, said robot tool supplies an application input signal of said at least one application input signal to said robot controller.

Using an application input signal from the robot tool is advantageous, since this allows the robot system to be operated based on output from the robot tool, e.g. output from a force sensor of the robot tool.

According to an embodiment of the invention, a peripheral device of said one or more peripheral devices is communicatively connected directly to said robot controller.

According to an embodiment of the invention, a peripheral device of said one or more peripheral devices is communicatively connected directly to said auxiliary control process.

According to an embodiment of the invention, a peripheral device of said one or more peripheral devices is communicatively connected directly to said auxiliary control software program.

According to an embodiment of the invention, each peripheral device of said one or more peripheral devices is communicatively connected directly to said robot controller.

According to an embodiment of the invention, each peripheral device of said one or more peripheral devices is communicatively connected directly to said auxiliary control process.

According to an embodiment of the invention, each peripheral device of said one or more peripheral devices is communicatively connected directly to said auxiliary control software program.

In the context of the present invention, communicative connections should be understood as connected so as to be able to communicate e.g. a peripheral device communicatively connected to the robot controller facilitates data communication therebetween. Communicatively connected directly may be understood as the communication is directly between the peripheral device and the robot controller i.e. without communicating via an auxiliary circuitry such as a PLC. For example, if a peripheral device is communicatively connected directly to the robot controller, a communicative connection between the peripheral device and the robot controller does not involve auxiliary circuitry, e.g. a PLC.

A communicative connection may be wired or wireless.

A direct connection between a peripheral device and the robot controller, the auxiliary control process and/or the auxiliary control software program is advantageous, since it reduces the need for auxiliary circuitry and reduces latency.

According to an embodiment of the invention, said robot control software program and said auxiliary control software program is implemented from a single programming device.

According to an embodiment of the invention, said robot control software program is compiled based on a configurable robot control software code.

According to an embodiment of the invention, said auxiliary control software program is compiled based on a configurable auxiliary control software code.

According to an embodiment of the invention, said robot control software code and said auxiliary control software code are configurable through said programming device.

According to an embodiment of the invention, said robot control software code and said auxiliary control software code are configurable through a programming environment of said programming device.

A programming environment may typically comprise software on the programming device intended for programming. A programming environment may for example comprise an integrated development environment, editor, compiler, interpreter, operating system, environment variables, libraries, auxiliary programs etc. A programming environment may also be linked to a cloud storage.

Facilitating programming of the robot controller from a single device and a single programming environment is advantageous, since it eases the process of programming. Further, it advantageously allows the two programs and/or the two codes to be synchronously evaluated, compiled, and/or implemented, which reduces time of debugging and testing the functionality of the robot system.

According to an embodiment of the invention, said programming device is arranged to perform a robot operation simulation indicative of operation of said robot system according to execution of said robot control process and said auxiliary control process based respectively on said robot control software program and said auxiliary control software program.

According to an embodiment of the invention, said robot operation simulation is performed based on said robot control software code and said auxiliary control software code.

According to an embodiment of the invention, an evaluation of operation feasibility is established based on said robot operation simulation, wherein said evaluation of operation feasibility is indicative of whether said robot system is able to operate as instructed by said robot control software code and said auxiliary control software code.

A robot operation simulation simulates operation of the robot system. The robot operation simulation may for example include timings of various signals, such as application input signals, logic signals, and logic output signals, and their interdependencies. Necessarily, the robot operation simulation may also include simulating the generation/establishment of these signals, e.g. by the robot controller and peripheral devices.

A robot operation simulation may also include simulating the physical size and movement of the robot arm, for example in relation to an application object and/or peripheral devices.

In some embodiments of the invention, when a robot operation simulation is performed, a user, e.g. of the programming device, receives an evaluation of the operation feasibility of the robot system according to execution of the robot control process and the auxiliary control process. This evaluation of the operation feasibility may inform the user whether the robot system is able to operate as intended and/or whether the intended operation is suboptimal, e.g. with respect to time consumption, power consumption, safety, wear of parts etc.

Performing a robot simulation is advantageous, since it allows the efficiency and the feasibility of any code and/or program to be evaluated. As such, the robot arm and the peripheral devices do not need to be operated to perform such an evaluation, which in turn may reduce risk of accidents and errors, as well as save time and power consumption. It further allows a larger degree of computer optimization of the robot operation.

According to an embodiment of the invention, a peripheral device of said one or more peripheral devices is a camera.

According to an embodiment of the invention, a peripheral device of said one or more peripheral devices is a 3D camera.

According to an embodiment of the invention, a peripheral device of said one or more peripheral devices is a sensor.

In various embodiments of the invention, a sensor or sensors may for example be light curtains, distance sensors, laser range sensors, safety matts, and/or position sensors,

According to an embodiment of the invention, a peripheral device of said one or more peripheral devices is a conveyer belt.

According to an embodiment of the invention, a peripheral device of said one or more peripheral devices is a peripheral display.

According to an embodiment of the invention, a peripheral device of said one or more peripheral devices is an indication light.

According to an embodiment of the invention, a peripheral device of said one or more peripheral devices is a valve.

According to an embodiment of the invention, a peripheral device of said one or more peripheral devices is a user input mechanism.

According to an embodiment of the invention, a peripheral device of said one or more peripheral devices is a mobile robot.

A mobile robot may for example be an autonomous mobile robot.

According to an embodiment of the invention, a peripheral device of said one or more peripheral devices is an actuator.

According to an embodiment of the invention, a peripheral device of said one or more peripheral devices is processing equipment, such as a CNC machine, a pinching machine, or a molding machine.

According to an embodiment of the invention, a peripheral device of said one or more peripheral devices is a PC or another computing device.

A user input mechanism may for example be a button, lever, keyboard, a touchpad, or any other mechanism arranged to be operated by a user to provide an output. A user input mechanism may also be a touchscreen functionality of a peripheral display. However, note that user input mechanisms are not limited to any of these examples.

According to an embodiment of the invention, a peripheral device of said one or more peripheral devices is an auxiliary robot system.

A robot arm may for example be installed along a production line, wherein it relies on tasks performed by one or more other robot arms, i.e. auxiliary robot systems. These auxiliary robot systems may in practice function as peripheral devices, from the point of view of the robot system of the invention.

According to an embodiment of the invention, the robot controller comprises a PLC software code import and translation module.

This is advantageous in that it has the effect, that existing PLC code automatically can be imported and if needed translated to be executable by the robot controller. Further it has the effect, that it is possible for a person experienced in writing PLC code to write a software program to the robot controller in a PLC program code language.

According to an embodiment of the invention, at least one of said one or more peripheral devices is an output device.

An output device may be understood as a device which receives an output of/from said robot controller. Other peripheral devices are input devices, which provides input to the robot controller. A peripheral device may also be an input/output device which both receives an output from and provides an input to the robot controller. Examples of an output devices are a conveyer belt, a peripheral display, an indication light, a valve, and an actuator. Examples of an input device is a sensor, a camera, and a user input mechanism. Examples of input/output devices are a conveyer belt, a valve, and an actuator, each giving inputs about their states.

An output device may thus typically be at least partially controlled by the auxiliary control process, e.g., via the logic output signal.

By having a peripheral device being an output device, which may be controlled by the robot controller via the auxiliary control process, a single controller (the robot controller) may perform control of both the robot arm and peripheral devices, leading to a simpler setup and potentially improved execution and coordination of various control processes, which is advantageous.

According to an embodiment of the invention, said one or more peripheral devices are part of an operation cycle of said robot system.

In other words, the peripheral devices are not exclusively used during, e.g., programming or maintenance of the robot system, but are used during actual operation of the robot system, such as repetitively performed operation cycles. Thus, the invention may potentially improve execution of operation cycles, which is advantageous. An example of a user input mechanism being used during operation, is a button which an operator activates, e.g., whenever an application object is ready to be handled by the robot.

An operation cycle may also be understood as a program cycle.

According to an embodiment of the invention, said application input signal is received from said one or more peripheral devices and/or said auxiliary control process is configured to control said one or more peripheral devices.

An aspect of the invention relates to a method for controlling operation of a robot system, said method comprising the steps of:
providing at least one application input signal to an auxiliary control process of a robot controller of said robot system from any of a peripheral device of said robot system and a robot control process of said robot controller,
generating one or more logic signals based on said at least one application input signal by executing said auxiliary control process based on an auxiliary control software program,
establishing at least one logic output signal based on said one or more logic signals by executing said auxiliary control process based on said auxiliary control software program,
providing said at least one logic output signal to any of said peripheral device and said robot control process of said robot controller, and
by said robot controller controlling a robot arm of said robot system by executing said robot control process based on a robot control software program, wherein said robot arm comprises a plurality of robot joints connecting a robot base to a robot tool flange, and wherein said robot controller is controlling any of said peripheral device and said robot arm based on said at least one logic output signal.

According to an embodiment of the invention, said method further comprises a step of controlling said peripheral device and said robot arm based on said at least one logic output signal.

According to an embodiment of the invention, said method further comprises a step of compiling a robot control software code to establish said robot control software program.

According to an embodiment of the invention, said method further comprises a step of compiling an auxiliary control software code to establish said auxiliary control software program.

Compiling may be understood as translating a computer code written in one programming language into another language. This translation may for example be from a high-level programming language to a lower level language to create an executable program.

According to an embodiment of the invention, said robot control software code and said auxiliary control software code are established using a programming environment on a programming device.

According to an embodiment of the invention, said method further comprises a step of simulating any of said steps of providing at least one application input signal, generating one or more logic signals, establishing at least one logic output signal, providing said at least one logic output signal, and by the robot controller controlling a robot arm, wherein said step of simulating is performed on said programming device and is based on said robot control software code and said auxiliary control software code.

Simulating any steps of the method of the invention may for example be used to establish a robot operation simulation.

According to an embodiment of the invention, said method further comprises a step of evaluating an operation feasibility of said robot control software code and said auxiliary control software code, wherein said operation feasibility is based on said step of simulating.

According to an embodiment of the invention, said operation feasibility is indicative of whether said robot system is able to operate as instructed by said robot control software code and said auxiliary control software code.

According to an embodiment of the invention, said step of establishing said at least one logic output signal is executed as a continuously running process by executing said auxiliary control process within a program cycle and independently of the state of said at least one application input signal.

According to an embodiment of the invention, said step of establishing said at least one logic output signal comprises the step of executing at plurality of sub-processes where each of said sub-processes is configured to establish at least one of said logic output signals (339).

According to an embodiment of the invention said sub-processes is executed concurrently.

Being able to operate as instructed by said robot control software code and said auxiliary control software code may also be understood as being able to operate as instructed by the robot control software program and the auxiliary control software program which are based respectively on the robot control software code and the auxiliary control software code.

Any advantage of any robot system of the invention may also apply to methods of the invention.

According to an embodiment of the invention, said step of providing said at least one application input signal is performed during execution of any of said auxiliary control process and said robot control process.

By providing an application input signal during execution of the auxiliary control process and/or the robot control process, it may advantageously be possible to improve operation of the robot system.

According to an embodiment of the invention, said step of providing at least one application input signal is performed during operation of said robot system.

In other words, the method is not exclusively performed during, e.g., programming or maintenance of the robot system, but is performed during actual operation of the robot system. Such operation may for example be normal operation. Such operation may be implemented as repetitively performed operation cycles.

In some embodiments, operation of the robot system may be quantified as execution of the auxiliary control process and execution of the robot control process.

According to an embodiment of the invention, said step of providing at least one application input signal is performed autonomously.

According to an embodiment of the invention, said robot control process and said auxiliary control process are separate processes performed on said robot controller.

In other words, the two processes are each performed on the robot controller but are distinct from each other. They may for example be performed on different cores of the robot processor. Even though the processes may optionally be separate processes, they may interact and be interdependent.

According to an embodiment of the invention, said method is performed on a pre-programmed robot system.

Thus, some embodiments of the invention relate to operation of a robot system which has already been programmed, and not to programming the robot system.

According to an embodiment of the invention, said one or more peripheral devices interact with an application object at least partially during execution of said auxiliary control process and/or said robot control process.

The interaction may for example be by moving/manipulating the object or sensing/detecting the object. Such interaction with an application object may be viewed in contrast to a peripheral device which do not interact with an application object, such as user input mechanism.

An aspect of the invention relates to a method for controlling operation of a peripheral device of a robot system comprising a robot arm, said method comprising the steps of:
providing at least one application input signal to an auxiliary control process of a robot controller of said robot system from any of a robot controller and one or more peripheral devices;
generating one or more logic signals based on said at least one application input signal by executing said auxiliary control process;
establishing, by said auxiliary control process, at least one output signal based on said one or more logic signals; and
providing said at least one output signal to a peripheral device of said one or more peripheral devices to control said peripheral device.

Thus, the invention permits advantageous control of a peripheral device of a robot system.

According to an embodiment of the invention, said at least one output signal is at least one logic output signal.

According to an embodiment of the invention, said robot controller controls said robot arm by executing a robot control process.

According to an embodiment of the invention, said method is facilitated on a robot system according to any of the aspects and embodiments of this disclosure.

An aspect of the invention relates to a distributed control system for a peripheral device of a robot system, wherein said robot system comprises a robot arm, a robot controller, and a peripheral device, wherein said robot arm comprises a plurality of robot joints connecting a robot base to a robot tool flange, wherein said robot controller is at least configured to execute a robot control process to control operation of said robot arm, wherein said distributed control system comprises:
a first control block located in said robot controller; and
a second control block located outside said robot controller,
   wherein said first control block and said second control block collectively control said peripheral device in executional coordination with said robot control process controlling said robot arm, wherein said executional coordination is performed via a communicative connection between said robot control process and said first control block.

By having a distributed control system for a peripheral device, the control of the peripheral device can be flexibly tailored to a particular application, which is advantageous. In particular, a part of the control of the peripheral device can advantageously be implemented in the robot controller.

The distribution of control among the two control blocks is not necessarily restricted to a particular distribution. Nevertheless, the first control block may preferably facilitate communication with the robot control process, such that the peripheral device can be controlled in executional coordination with said robot control process controlling said robot arm. The executional coordination between the control blocks and the robot control process may be understood as two separate control processes (on control blocks and the robot control process, respectively), in which at least one of the processes are being executed with respect to the other of the two processes. That is, control of the robot arm may rely on control of the peripheral device and/or vice versa.

According to an embodiment of the invention, said second control block is located in said peripheral device.

According to an embodiment of the invention, said first control block and said second control block are located in separate casings.

Separate casings permit a clear separation, protection, and labelling of hardware, which is advantageous.

According to an embodiment of the invention, said first control block facilitates the auxiliary control process according to any of the aspects and embodiments of this disclosure.

According to an embodiment of the invention, said robot system is the robot system according to any of the aspects and embodiments of this disclosure.

An aspect of the invention relates to a peripheral device controller configured to execute:
a robot control process based on a robot control software program; and
an auxiliary control process based on an auxiliary control software program,
   wherein execution of said robot control process performed by said peripheral device controller results in operation of a robot arm communicatively connected to said peripheral device controller;
   wherein execution of said auxiliary control process performed by said peripheral device controller results in establishing one or more logic signals based on at least one application input signal received from any of said robot control process and one or more peripheral devices;
   wherein said auxiliary control process is configured to establish at least one logic output signal based on said one or more logic signals and, based on said at least one logic output signal, configured to control operation of any of said robot control process and said one or more peripheral devices.

Having a peripheral device controller being able to further control a robot arm is advantageous. It may for example be advantageous for at least any of the same of similar reasons that having a robot control process and an auxiliary control process on a robot controller is advantageous.

According to an embodiment of the invention, said peripheral device controller has any of the features of the robot controller of any of the aspects and embodiments of this disclosure.

### BRIEF DESCRIPTION OF THE DRAWINGS

FIG. 1 illustrates a robot arm according to the present invention;

FIG. 2 illustrates a simplified structural diagram of the robot arm and part of the robot controller;

FIG. 3a-3b respectively illustrate a robot system according to embodiments of the invention;

FIG. 4a-4b illustrate a robot system and an associated logic timing diagram according to an embodiment of the invention;

FIG. 5 illustrates a robot system connected to a programming device according to an embodiment of the invention;

FIG. 6 illustrates a method according to some embodiments of the invention; and

FIG. 7 illustrate a method according to some other embodiment of the invention.

### DETAILED DESCRIPTION OF THE INVENTION

The present invention is described in view of exemplary embodiments only intended to illustrate the principles of the present invention. The skilled person will be able to provide several embodiments within the scope of the claims.

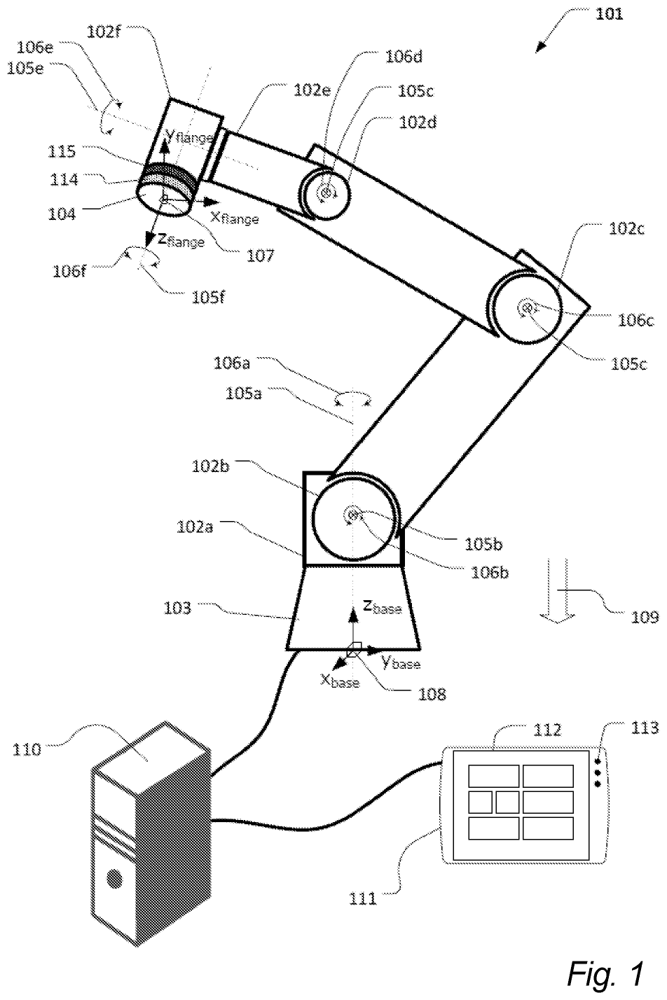

FIG. 1 illustrates a robot arm 101 comprising a plurality of robot joints 102a, 102b, 102c, 102d, 102e, 102f connecting a robot base 103 and a robot tool flange 104. A base joint 102a is configured to rotate the robot arm 101 around a base axis 105a (illustrated by a dashed dotted line) as illustrated by rotation arrow 106a; a shoulder joint 102b is configured to rotate the robot arm around a shoulder axis 105b (illustrated as a cross indicating the axis) as illustrated by rotation arrow 106b; an elbow joint 102c is configured to rotate the robot arm around an elbow axis 105c (illustrated as a cross indicating the axis) as illustrated by rotation arrow 106c, a first wrist joint 102d is configured to rotate the robot arm around a first wrist axis 105d (illustrated as a cross indicating the axis) as illustrated by rotation arrow 106d and a second wrist joint 102e is configured to rotate the robot arm around a second wrist axis 105e (illustrated by a dashed dotted line) as illustrated by rotation arrow 106e. Robot joint 102f is a tool joint comprising the robot tool flange 104, which is rotatable around a tool axis 105f (illustrated by a dashed dotted line) as illustrated by rotation arrow 106f. The illustrated robot arm is thus a six-axis robot arm with six degrees of freedom with six rotational robot joints, however it is noticed that the present invention can be provided in robot arms comprising less or more robot joints and also other types of robot joints such as prismatic robot joints providing a translation of parts of the robot arm for instance a linear translation.

A robot tool flange reference point 107 also known as a Tool Center Point (TCP) is indicated at the robot tool flange and defines the origin of a tool flange coordinate system defining three coordinate axis x_{flange}, y_{flange}, z_{flange}. In the illustrated embodiment the origin of the robot tool flange coordinate system has been arrange on the tool flange axis 105f with one axis (z_{flange}) parallel with the tool flange axis and with the other axes x_{flange}, y_{flange} parallel with the outer surface of the robot tool flange 104. Further a base reference point 108 is coincident with the origin of a robot base coordinate system defining three coordinate axes x_{base}, y_{base}, z_{base}. In the illustrated embodiment the origin of the robot base coordinate system has been arrange on the base axis 105a with one axis (z_{base}) parallel with the base axis 105a and with the other axes x_{base}, y_{base} parallel with the bottom surface of the robot base. The direction of gravity 109 in relation to the robot arm is also indicated by an arrow and it is to be understood that the robot arm can be arrange at any position and orientation in relation to gravity.

The robot arm comprises at least one robot controller 110 configured to control the robot arm 101 and can be provided as a computer comprising in interface device 111 enabling a user to control and program the robot arm. The controller 110 can be provided as an external device as illustrated in FIG. 1 or as a device integrated into the robot arm or as a combination thereof. The interface device can for instance be provided as a teach pendent as known from the field of industrial robots which can communicate with the controller 110 via wired or wireless communication protocols. The interface device can for instanced comprise a display 112 and a number of input devices 113 such as buttons, sliders, touchpads, joysticks, track balls, gesture recognition devices, keyboards etc. The display may be provided as a touch screen acting both as display and input device. The interface device can also be provided as an external device configured to communicate with the robot controller 110, for instance as smart phones, tablets, PCs, laptops, etc.

The robot tool flange 104 comprises a force-torque sensor 114 (sometimes referred to simply as fore sensor) integrated into the robot tool flange 104. The force-torque sensor 114 provides a tool flange force signal indicating a force-torque provided at the robot tool flange. In the illustrated embodiment the force-torque sensor is integrated into the robot tool flange and is configured to indicate the forces and torques applied to the robot tool flange in relation to the robot tool flange reference point 107. The force sensor 114 provides a force signal indicating a force provided at the tool flange. In the illustrated embodiment the force sensor is integrated into the robot tool flange and is configured to indicate the forces and torques applied to the robot tool flange in relation to the reference point 107 and in the tool flange coordinate system. However, the force-torque sensor can indicate the force-torque applied to the robot tool flange in relation to any point which can be linked to the robot tool flange coordinate system. In one embodiment the force-torque sensor is provided as a six-axis force-torque sensor configured to indicate the forces along and the torques around three perpendicular axes. The force-torque sensor can for instance be provided as any force-torque sensor capable of indicating the forces and torques in relation to a reference point for instance any of the force-torque sensors disclosed by WO2014/110682A1, U.S. Pat. No. 4,763,531, US2015204742. However, it is to be understood that the force sensor in relation to the present invention not necessarily need to be capable of sensing the torque applied to the tool sensor. It is noted that the force-torque sensor may be provided as an external device arranged at the robot tool flange or omitted.

An acceleration sensor 115 is arranged at the robot tool joint 102f and is configured to sense the acceleration of the robot tool joint 102f and/or the acceleration of the robot tool flange 104. The acceleration sensor 115 provides an acceleration signal indicating the acceleration of the robot tool joint 102f and/or the acceleration of the robot tool flange 104. In the illustrated embodiment the acceleration sensor is integrated into the robot tool joint and is configured to indicate accelerations of the robot tool joint in the robot tool coordinate system. However, the acceleration sensor can indicate the acceleration of the robot tool joint in relation to any point which can be linked to the robot tool flange coordinate system. The acceleration sensor can be provided as any accelerometer capable of indicating the accelerations of an object. The acceleration sensor can for instance be provided as an IMU (Inertial Measurement Unit) capable of indicating both linear acceleration and rotational accelerations of an object. It is noted that the acceleration sensor may be provided as an external device arranged at the robot tool flange or omitted.

Each of the robot joints comprises a robot joint body and an output flange rotatable or translatable in relation to the robot joint body and the output flange is connected to a neighbor robot joint either directly or via an arm section as known in the art. The robot joint comprises a joint motor configured to rotate or translate the output flange in relation to the robot joint body, for instance via a gearing or directly connected to the motor shaft. The robot joint body can for instance be formed as a joint housing and the joint motor can be arranged inside the joint housing and the output flange can extend out of the joint housing. Additionally, the robot joint comprises at least one joint sensor providing a sensor signal indicative of at least one of the following parameters: an angular and/or linear position of the output flange, an angular and/or linear position of the motor shaft of the joint motor, a motor current of the joint motor or an external force and/or torque trying to rotate the output flange or motor shaft. For instance, the angular position of the output flange can be indicated by an output encoder such as optical encoders, magnetic encoders which can indicate the angular position of the output flange in relation to the robot joint. Similarly, the angular position of the joint motor shaft can be provided by an input encoder such as optical encoders, magnetic encoders which can indicate the angular position of the motor shaft in relation to the robot joint. It is noted that both output encoders indicating the angular position of the output flange and input encoders indicating the angular position of the motor shaft can be provided, which in embodiments where a gearing have been provided makes it possible to determine a relationship between the input and output side of the gearing. The joint sensor can also be provided as a current sensor indicating the current through the joint motor and thus be used to obtain the torque provided by the motor. For instance, in connection with a multiphase motor, a plurality of current sensors can be provided in order to obtain the current through each of the phases of the multiphase motor. It is also noted that some of the robot joints may comprise a plurality of output flanges rotatable and/or translatable by joint actuators, for instance one of the robot joints may comprise a first output flange rotating/translating a first part of the robot arm in relation to the robot joint and a second output flange rotating/translating a second part of the robot arm in relation to the robot joint.

The robot controller 110 is configured to control the motions of the robot arm by controlling the motor torque provided to the joint motors based on a dynamic model of the robot arm, the direction of gravity acting 109 and the joint sensor signal.

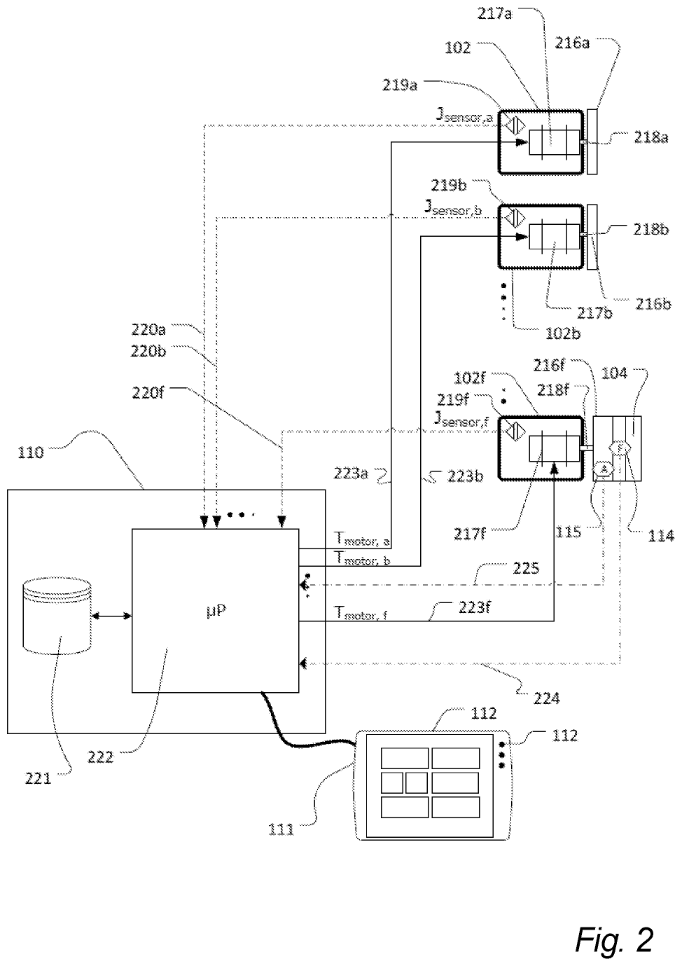

FIG. 2 illustrates a simplified structural diagram of the robot arm 101 illustrated in FIG. 1. The robot joints 102a, 102b and 102f have been illustrated in structural form and the robot joints 102c, 102d, 102e and the robot links connecting the robot joints have been omitted for the sake of simplicity of the drawing. Further the robot joints are illustrated as separate elements however it is to be understood that they are interconnected as illustrated in FIG. 1. The robot joints comprise an output flange 216a,216b,216f and a joint motor 217a, 217b, 217f or another kind of actuator, where the output flange 216a,216b,216f is rotatable in relation to the robot joint body. The joint motors 217a, 217b, 217f are respectively configured to rotate the output flanges 216a, 216b, 216f via an output axle 218a, 218b, 218f. It is to be understood that the joint motor or joint actuator may be configured to rotate the output flange via a transmission system such as a gear (not shown). In this embodiment the output flange 216f of the tool joint 123f constitutes the tool flange 104. At least one joint sensor 219a, 219b, 219f providing a sensor signal 220a, 220b, 220f indicative of at least one joint sensor parameter J_{sensor,a}, J_{sensor,b}, J_{sensor,f} of the respective joint. The joint sensor parameter can for instance indicate a pose parameter indicating the position and orientation of the output flange in relation to the robot joint body, an angular position of the output flange, an angular position of a shaft of the joint motor, a motor current of the joint motor. For instance, the angular position of the output flange can be indicated by an output encoder such as optical encoders, magnetic encoders which can indicate the angular position of the output flange in relation to the robot joint. Similar, the angular position of the joint motor shaft can be provided by an input encoder such as optical encoders, magnetic encoders which can indicate the angular position of the motor shaft in relation to the robot joint. The motor currents can be obtained and indicated by current sensors.

The robot controller 110 comprises a processer 220 and memory 221 and is configured to control the joint motors of the robot joints by providing motor control signals 223a, 223b, 223f to the joint motors. The motor control signals 223a, 223b, 223f are indicative of the motor torque T_{motor,a}, T_{motor,b}, and T_{motor,f} that each joint motor shall provide to the output flanges and the robot controller 110 is configured to determine the motor torque based on a dynamic model of the robot arm as known in the prior art. The dynamic model makes it possible for the controller 110 to calculate which torque the joint motors shall provide to each of the joint motors to make the robot arm perform a desired movement. The dynamic model of the robot arm can be stored in the memory 221 and be adjusted based on the joint sensor parameters J_{sensor,a}, J_{sensor,b}, J_{sensor,f} For instance, the joint motors can be provided as multiphase electromotors and the robot controller 110 can be configured to adjust the motor torque provided by the joint motors by regulating the current through the phases of the multiphase motors as known in the art of motor regulation.

Robot tool joint 102f comprises the force sensor 114 providing a tool flange force signal 224 indicating a force-torque FT_{flange} provided to the tool flange. For instance, the force signal-torque FT_{flange} can be indicated as a force vector \vec{Fₛₑₙₛₒᵣ^{flange}} and a torque vector \vec{Tₛₑₙₛₒᵣ^{flange}} in the robot tool flange coordinate system:

$$\vec{{F}_{s e n s o r}^{flange}} = ( \begin{matrix}{F}_{x , s e n s o r}^{flange} \\ {F}_{y , sensor}^{flange} \\ {F}_{z , sensor}^{flange}\end{matrix} ) \qquad eq . 1$$

where F_{x,sensor}^{flange} is the indicated force along the x_{flange} axis, F_{y,sensor}^{flange} is the indicated force along the y_{flange} axis and F_{z,sensor}^{flange} is the indicated force along the z_{flange} axis.

In addition to the above, the robot controller 110 of the present invention may include a PLC code import/translate module (not illustrated). Such module facilitates importing PLC code stored e.g. on a PLC or on a PLC code developing tool connected to the robot controller either directly (e.g. wired or wireless connection) or indirectly (via e.g. the internet). Further, such module may facilitate translation of the PLC code to robot control software executable the robot controller.

In an embodiment where the force sensor is provided as a combined force-torque sensor the force-torque sensor can additionally also provide a torque signal indicating the torque provide to the tool flange, for instance as a separate signal (not illustrated) or as a part of the force signal. The torque can be indicated as a torque vector in the robot tool flange coordinate system:

$$\vec{{T}_{s e n s o r}^{flange}} = ( \begin{matrix}{T}_{x , s e n s o r}^{flange} \\ {T}_{y , sensor}^{flange} \\ {T}_{z , sensor}^{flange}\end{matrix} ) \qquad eq . 2$$

where T_{x,sensor}^{flange} is the indicated torque around the x_{flange} axis, T_{y,sensor}^{flange} is the indicated torque around the y_{flange} axis and T_{z,sensor}^{flange} is the indicated torque around the z_{flange} axis.

Robot tool joint 102f comprises the acceleration sensor 115 providing an acceleration signal 225 indicating the acceleration of the robot tool flange where the acceleration may be indicated in relation to the tool flange coordinate system

$$\vec{{A}_{s e n s o r}^{flange}} = ( \begin{matrix}{A}_{x , s e n s o r}^{flange} \\ {A}_{y , sensor}^{flange} \\ {A}_{z , sensor}^{flange}\end{matrix} )$$

where A_{x,sensor}^{flange} or is the sensed acceleration along the x_{flange} axis, A_{y,sensor}^{flange} is the sensed acceleration along the y_{flange} axis and A_{z,sensor}^{flange} is the sensed acceleration along the z_{flange} axis.

In an embodiment where the acceleration sensor is provided as a combined accelerometer/gyrometer (e.g. an IMU) the acceleration sensor can additionally provide an angular acceleration signal indicating the angular acceleration of the output flange in relation to the robot tool flange coordinate system, for instance as a separate signal (not illustrated) or as a part of the acceleration signal. The angular acceleration signal can indicate an angular acceleration vector \vec{αₛₑₙₛₒᵣ^{flange}} in the robot tool flange coordinate system

$$\vec{{α}_{s e n s o r}^{f l a n g e}} = ( \begin{matrix}{α}_{x , sensor}^{f l a n g e} \\ {α}_{y , sensor}^{f l a n g e} \\ {α}_{z , sensor}^{f l a n g e}\end{matrix} ) \qquad eq . 3$$

where α_{x,sensor}^{flange} is the angular acceleration around the x_{flange} axis α_{y,sensor}^{flange} is the angular acceleration around the y_{flange} axis and α_{z,sensor}^{flange} is the angular acceleration around the z_{flange} axis.

The force sensor and acceleration sensor of the illustrated robot arm are arranged at the robot tool joint 102f; however, it is to be understood that the force sensor and acceleration sensor can be arrange at any part of the robot arm and that a pluralities of such sensors can be provided at the robot arm.

In an exemplary embodiment of the invention, the robot arm 101 is part of a robot system, that in addition to the robot arm 101 also comprises two peripheral devices 336, which in this particular embodiment is an object sensor and a conveyer belt. A robot tool is attached to the robot tool flange and is arranged to perform welding of an application object. The object sensor is arranged to detect the presence of an application object at a welding position. The auxiliary control process receives application input signals from the object sensor and the robot control process, upon which logic signals are established. Further, the auxiliary control process provides logic output signals to the conveyer belt and the robot control process based on the logic signals. When no application object is at the welding position, the auxiliary control process is arranged to activate the conveyer belt via a logic output signal. Then, when the object sensor detects an object at the welding position, the auxiliary control process stops the conveyer belt, and initiates movement of the robot arm and welding, via a logic output signal to the robot control process. When welding, as controlled by the robot control process, has completed, movement of the conveyer belt is initiated based on the application input signal from the robot control process. From here, the robot system is ready the receive a new application object via the conveyer belt to repeat the above explained welding process.

Accordingly, the robot arm 101 and the peripheral devices 336 in the above described exemplary embodiment of the invention are all controlled directly from the robot controller 110 i.e. without the use of additional controllers external to the robot controller as will be described in the following.

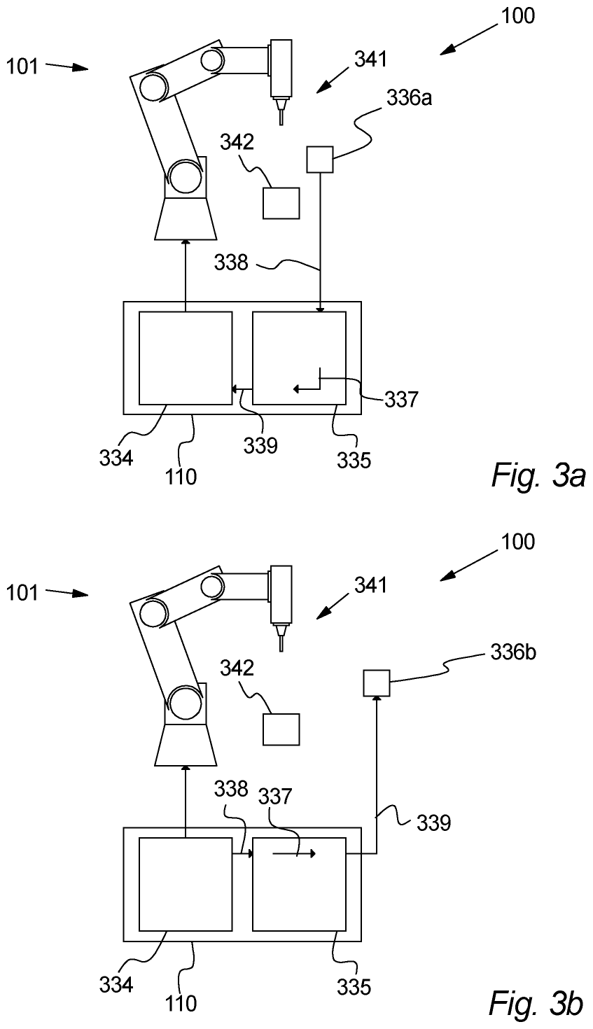

FIG. 3a-b respectively illustrate a robot system 100 according to embodiments of the invention. Each of these illustrated embodiments comprise a peripheral device 336a,336b communicatively connected to an auxiliary control process 335.

In both of these exemplary embodiments, the robot arm 101 is configured to apply its tool 341 to an application object 342. The application object, sometimes referred to as a workpiece, should be understood as the object handled by the robot arm 101 i.e. the object, which is moved, packed, painted, welded, polished, etc. by the robot arm 101. In addition to the description of motion of the robot arm described above, the motion of the robot arm relative to the application object 342 is controlled by the robot control process 334 of the robot controller 110. The communication between the robot control process 334 and the peripheral device 336a, 336b is facilitated by the auxiliary control process 335 of the robot controller 110. As described above, the robot control process 334 is based on a robot control software program, and, similarly, the auxiliary control process 335 is based on an auxiliary control software program.

As described below, peripheral devices 336, which in the prior art, typically are controlled by a PLC, are according to the present invention controlled by the robot controller 110. This is possible by dividing the software executed by the robot controller 110 into a robot control software code and in an auxiliary control software code. The robot control software code would typically be developed based on the known principles of robot programming e.g. as described above, whereas the auxiliary control software code typically would be developed according to Logic programming principles such as PLC programming executable by the robot controller 110.

The embodiment illustrated in FIG. 3a comprises a peripheral device 336a which is a sensor able to detect the presence of the application object 342, for instance within range of the tool 341 connected to the robot arm 101. The sensor 336a is able to provide an application input signal 338 indicative of the presence of an application object 342 to the auxiliary control process 335, which in turn is able to process this application input signal 338 to provide a logical output signal 339 to the robot control process 334. Operation of this particular embodiment of the inventive robot system 100 may for example take place as follows.

The sensor 336a continuously detects whether an application object 342 is located in the vicinity of the sensor 336a at a position where the robot arm 101 is able to apply its tool 341 to the application object 342. The application input signal 338 is indicative of the presence of the application object 342. When no application object 342 is detected by the sensor 336a, the application input signal 338 is processed into a logic signal 337 which is low, e.g. the application input signal 338 from the sensor 336a is an analogue voltage, and when the signal 338 is below 2.5 V, the analogue voltage is processed into a logic signal 337 which is a binary “0”, and when the signal 338 is above 2.5 V, the analogue voltage is processed into a logic signal 337 which is a binary “1”. This logic signal 337 is used as logic output signal 339 which is provided to the robot control process 334. While the robot control process 334 is receiving a low logic output signal 339, the robot arm 101 is operated by the robot control process 334 to be in a waiting position, where the robot arm 101 does not apply its tool 341. When an application object 342 is moved to the vicinity of the detector 336a, the application input signal 338 changes accordingly, and in the auxiliary control process 335, the application input signal 338 is now processed into a logic signal 337 which is high, which in turn is provided to the robot control process 334 as a logical output signal 339. Upon receiving a high logical output signal 339, the robot arm 101 is operated by the robot control process 334 to apply its tool 341 to the application object 342. The tool 341 may for example be applied for a predefined amount of time or by moving the robot arm in a predefined movement pattern. When the tool 341 has been applied, the robot arm 101 is operated by the robot control process 334 to be in a waiting position again. The robot arm 101 cannot be operated to apply its tool 341 to an application object 342 until it has received a low logical output signal 339 which is indicative that the application object 342, which had the robot tool 341 applied to it, has been removed. After removal of the application object 342, the process can restart, i.e. a new application object 342 may be moved to the vicinity of the sensor 336a, such that the robot tool 341 is applied again.

The embodiment illustrated in FIG. 3b comprises a peripheral device 336b which is a visual display, indicative of the status of the robot system 100. In this embodiment, the robot control process 334 is able to provide an application input signal 338 indicative of a status of the robot arm 101, e.g. indicative of whether the tool 341 is currently being applied to an application object 342 or not. The auxiliary control process 335 is arranged to process the application input signal 338 into a logic signal 337 which is also used as a logic output signal which is sent to the display 336b. The display 336b thus receives either a high or a low logic output signal, depending on the application input signal 338, and may correspondingly display whether the robot arm 101 is currently being operated or not. The display 336b may further process the received logic output signal 339, for example to establish and display a duration of time in which the robot arm 101 has been operated.

The embodiments of the invention described with respect to FIGS. 3a and 3b are advantageous in that the logic signals 339, whether they are input to the robot control process 334 (FIG. 3a) or output from the robot control process 334 (FIG. 3b), are established without a PLC as required in the prior art.

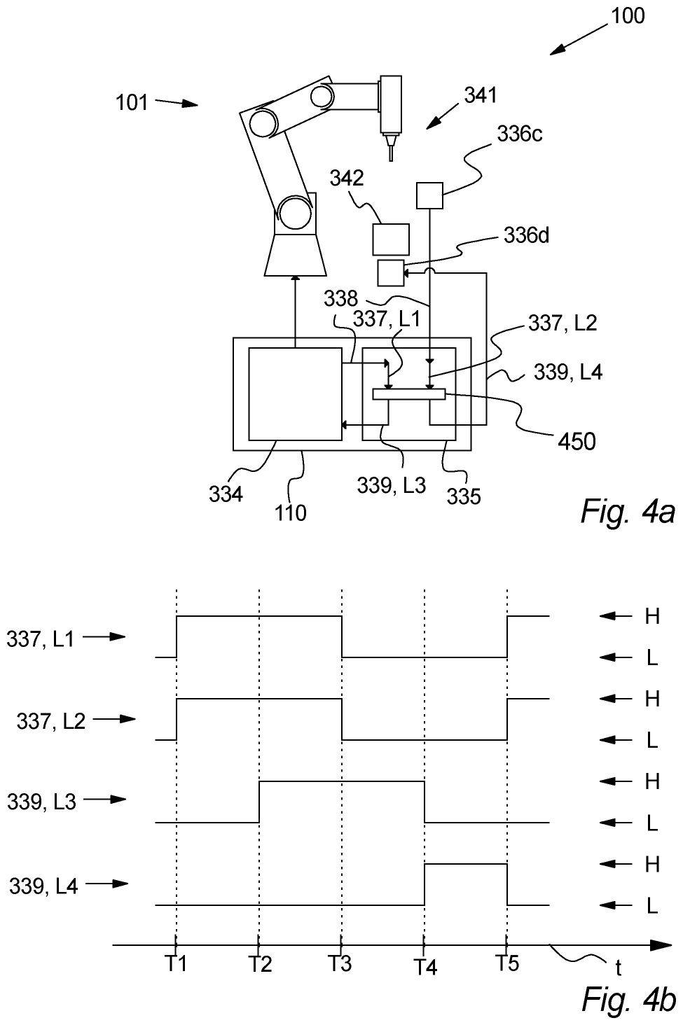

FIG. 4a-4b illustrate a robot system 100 and an associated logic timing diagram according to an embodiment of the invention. This embodiment comprises two peripheral devices 336c, 336d communicatively connected to the auxiliary control process 335. The logic timing diagram illustrated in FIG. 4b, shows four logic signals/logic output signals L1, L2, L3, L4 associated with operation of the robot system 100 illustrated in FIG. 4a, where the four signals are displayed relative to a time axis t and where each signal is either high denoted H on FIG. 4b or low denoted L on FIG. 4b at a certain point in time denoted t on FIG. 4b.

In this exemplary embodiment, the robot arm 101 is configured to apply its tool 341 to an application object 342 brought to the robot arm 101 e.g. on a conveyer belt. A camera is used to analyze whether the application object 342 is correctly placed relative to the robot arm 101. The camera is the first peripheral device 336c and the conveyer belt is the second peripheral device 336d.

Motion of the robot arm 101 is controlled by the robot control process 334 of the robot controller 110. The communication between the robot control process 334 and the peripheral devices 336c, 336d is facilitated by the auxiliary control process 335 of the robot controller 110.

The auxiliary control process 335 receives an application input signal 338 from the robot control process 334, which is processed into a robot arm ready logic signal 337, L1 indicative of whether the robot arm 101 is ready or not. The auxiliary control process 335 further receives an application input signal 338 from the camera 336c, which is processed into a peripheral camera logic signal 337, L2 indicative of whether the application object 342 is correctly placed relative to the robot arm 101 or not.

The auxiliary control process 335 generate logic output signals 339, L3, L4 based on the logic signals 337, L1, L2 and logic operations 450 applied to the logic signals 337, L1, L2. As described with respect to FIGS. 3a and 3b, the robot 101 according to the present invention controls its peripheral devices 336 without a PLC leading to the advantages described above include reduction of hardware and robot system installation time and footprint.

Operating the robot system 100 may for example take place as follows, with reference to FIG. 4a-4b.

A robot arm operation logic output signal 339, L3 is based on the robot arm ready logic signal 337, L1 and the peripheral camera logic signal 337, L2 and is provided to the robot control process 334. When the two signals 337, L1, L2 become high at time T1, i.e. when the robot is ready and an application object 342 is correctly placed, the robot arm operation logic output signal 339, L3 becomes high as well, e.g. at a later clock period at time T2. Consequently, the robot control process 334 initiates a predetermined operation of the robot arm 101 such that the tool 341 is applied to the application object 342. The robot control process 334 further changes the application input signal 338 such that the robot arm ready logic signal 337, L1 is switched to low at time T3. The robot arm operation logic output signal L3 is kept high for the duration of the operation of the robot and its tool and the robot arm ready logic signal 337, L1 is low until the operation of the robot arm is complete at time T4. At time T4 when the operation of the robot is completed, the robot arm operation logic output signal 339, L3 becomes low, upon which a peripheral conveyer belt logic output signal 339, L4 becomes high for a predetermined amount of time until time T5. Accordingly, the application object 342 is moved by the conveyer belt 336d during the time between time T4 and T5, and consequently the peripheral camera logic signal 337, L2 becomes low. In other words, the conveyer belt 336d is operated to replace the application object 342, which have just had the tool 341 applied to it, with a new application object 342, which have not yet had the tool 341 applied to it. At time T5, the peripheral camera logic signal 337, L2 becomes high, indicating that the operation cycle is ready to repeat.

Note that the timing in change of the signals L1-L4 of FIG. 4b is only for illustrative purposes and if an operation as described above should be implemented in a real robot system 101, the timing of the change of signals from high to low could be optimized.

In this exemplary embodiment, the robot controller 110 comprises a multi-core processor, where the robot control process 334 is executed on one group of cores of the multi-core processor, and the auxiliary control process 335 is executed on another separate group of cores of the multi-core processor. This ensures that the two processes 334, 335 can be parallelly executed by the robot controller 110.

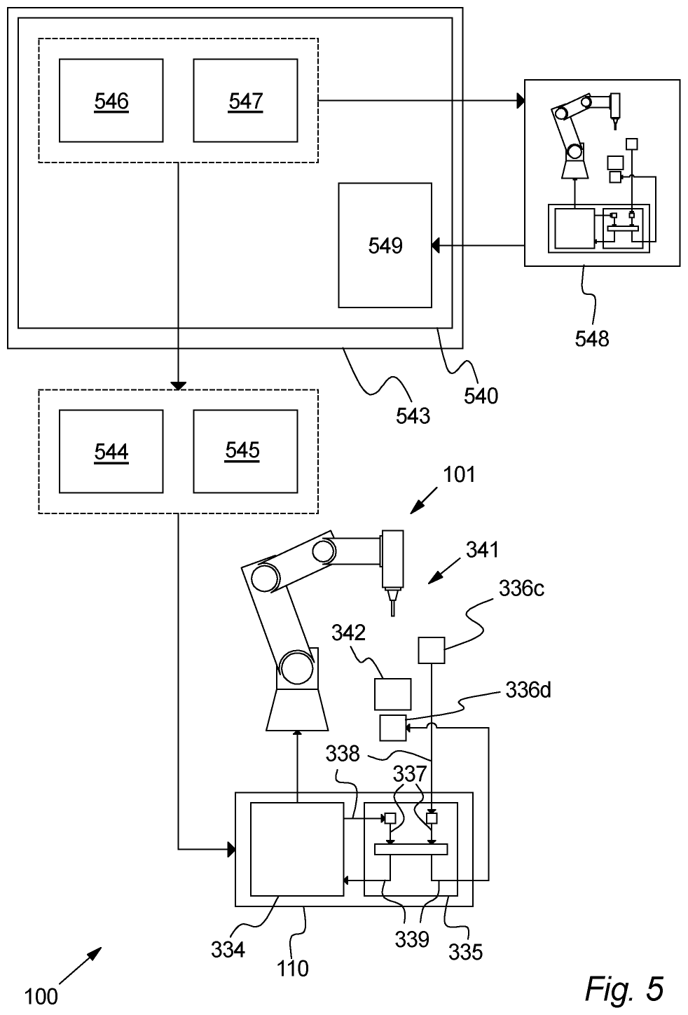

FIG. 5 illustrates a robot system 100 connected to a programming device 543 according to an embodiment of the invention.

Not including the programming device 543, the illustrated robot system 100 is substantially similar to the robot system illustrated in FIG. 4a, and some details regarding the robot system 100 and its operation are thus excluded in order to not provide repetitive or unnecessary details.

The programming device 543 associated with this embodiment comprise a graphical user interface 540, which enables a user to generate, evaluate, and edit robot control software code 546 and auxiliary control software code 547 upon which the robot control process 334 and the auxiliary control process 335 are based, respectively. In the illustration of FIG. 5, the codes 546, 547 are grouped together in a box. In some embodiments of the invention, a user is able to edit the two different pieces of software code 546, 547 in a single programming environment. In other embodiments, two separate programming environments are required.

The programming device allows the user to compile the robot control software code 546 and auxiliary control software code 547 into program formats which are readable by the robot controller 110. Consequently, the robot controller 110 is able to control a robot control process 334 based on execution of the robot control software program 544 and control an auxiliary control process 335 based on execution of the auxiliary control software program 545. In the illustration of FIG. 5, the programs 544, 545 are grouped together in a box.

The programming device 543 is arranged to facilitate a robot operation simulation 548 based on the robot control software code 546 and the auxiliary control software code 547. The robot operation simulation 548 is arranged to simulate operation of the robot system 100 according to execution of the robot control process 334 based on the robot control software program 544 and execution of the auxiliary control process 335 based on the auxiliary control software program 545. In this way, it is possible to simulate the effect of changes both in the robot control software code 546 and in the auxiliary control software code 547 on the respective robot and auxiliary control processes 334, 335.

For example, the robot operation simulation 548 may simulate operation of the robot system 100 as described in relation to FIG. 4a-4b. For example, the robot operation simulation 548 may include representations of logic signals 337, logic output signals 339, logic operations established by the auxiliary control process 335 based on the auxiliary control software program 545, and any time durations and timings relating to these signals and operations.

The robot operation simulation 548 is arranged to generate simulation results 549 which are presented to a user. Accordingly, the robot operation simulation 548 may be used to evaluate an operation feasibility of the robot control software code 546 and the auxiliary control software code 547 and changes made thereto. The operation feasibility may for example indicate whether the robot system 100 is able to operate as instructed by the robot and auxiliary control software code 546, 547. For example, a programming error introduced by a user editing the software code 546, 547 or integrating the robot system 101 may result in an operation of the robot system 100 which does not proceed as intended by the user, e.g. if timings or logic operations are inaccurate, and accordingly, a robot operation simulation may provide a notice to a user of the system.

The robot operation simulation 548 may further comprise a simulation of the physical motion of the robot arm 101 and/or any moving of peripheral devices 336 to evaluate whether this motion is feasible according to the intended operation of the robot system 100.

In exemplary robot control software code 546 and auxiliary control software code 547, the robot system 100 has erroneously been programmed to apply its robot tool 341 while an application object 342 is not present. When performing a robot operation simulation 548, the user receives simulation results 549, which warns the user that, according to the code, the robot system is arranged to apply its robot tool while an application object is not present.

In another exemplary robot control software code 546 and auxiliary control software code 547, the user receives a warning that an allocated time duration is too short to perform a necessary operation, e.g. the time duration for applying a robot tool is too short, or the time duration for moving a conveyer belt is too short.

In another exemplary robot control software code 546 and auxiliary control software code 547, the user receives a warning that an allocated time duration is too long and may be reduced to increase efficiency of the robot system.

In another exemplary embodiment, from a simulation of the robot control software code 546 and auxiliary control software code 547, the user is able to observe if logic operations may not yield the intended output. For example, a conveyer belt as activated based on a logic output signal, which in turn is based on a logic AND gate applied to logic signals from an object sensor and the robot control process. The logic signal from the object sensor is high when an application object is present, the logic signal from the robot control process high when the robot arm is idle, and the conveyer belt is moved upon a high logic output signal. Consequently, the conveyer belt moves the application object upon an idle signal, but the conveyer belt may not necessarily successfully move a new application object to the robot arm, and therefore a user of the system receives a warning from the simulation. The user may for example fix this problem by implementing logic operations, which ensures that the conveyer belt is also moved when no application object is present

In another exemplary robot control software code 546 and auxiliary control software code 547, the user receives a warning that the programmed physical movement of the robot arm is not possible, e.g. it may collide with itself or its surroundings.

In another exemplary embodiment, the simulation results 549 comprises parameters indicative of the expected performance of the robot system 100 according to the robot control software code 546 and auxiliary control software code 547. For example, cycle duration, power consumption, relative idling duration of robot arm etc.

In some embodiments of the invention, a system similar to the one illustrated in FIG. 5 may be used for monitoring the robot system. For example, monitoring the communication between one or more peripheral devices and the robot controller. For example, this communication may be recorded to obtain a peripheral signal representation. This peripheral signal representation may be provided to an operation signal history in a digital storage. The operation signal history may for example be one or more data files. Based on the stored peripheral signal representation, a past operation of the robot system may be tracked/simulated. Thus, robot operation simulation 548, in the context of the present invention, may also be interpreted as simulating an operation which has already been performed. Such a simulation may then for example be basis for optimizing, troubleshooting, predictive maintenance, and/or changing future operations of the robot system. Such simulations may typically be based on at least the peripheral signal representations, but may also be based on other inputs, models of the robot system, and/or other recoded data.

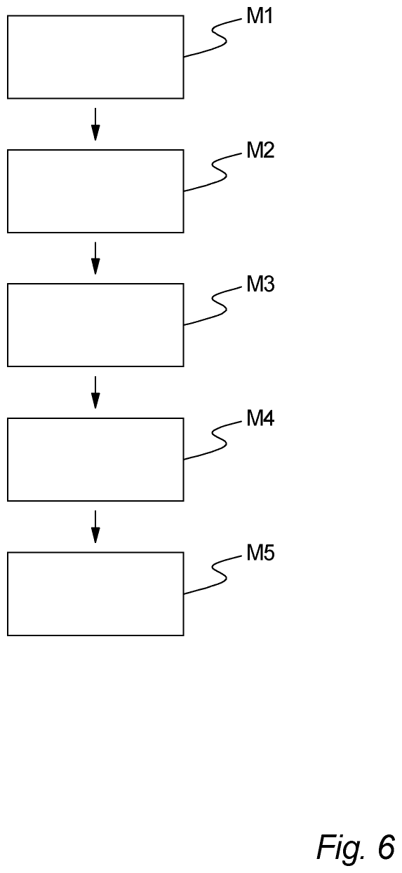

FIG. 6 illustrates a method according to some embodiments of the invention. The method is for controlling operation of a robot system and comprises six steps M1-M5.

In a first step M1 of the method, one or more application input signals 338 are transmitted to an auxiliary control process 335 of a robot controller 110. The one or more application input signals 338 may be transmitted from the robot control process 334, from one or more peripheral devices 336 or from both the robot control process 334 and one or more peripheral devices 336.

In a next step M2 of the method, one or more logic signals 337 are generated based on the one or more application input signals 338 by executing the auxiliary control process based on an auxiliary control software program. The auxiliary control process may for example take place on a processor of a computer such as the robot controller 110, e.g. on one or more cores of a multicore processor. In some embodiments of the invention, an application input signal 338 is used as a logic signal 337.

In a next step M3 of the method, at least one logic output signal 339 is established by executing the auxiliary control process based on an auxiliary control software program. The at least one logic output signal 339 may be based on the one or more logic signals 337 which are established by converting or processing one or more application input signals 338. The status/value (high or low) of the logic signals 337 may then, dependent on logic Boolean operators of the auxiliary control software code result in one or more logic output signals 339 (the value of a logic output signal 339 is typically 0 or 1/low or high).

In a next step M4 of the method, the at least one logic output signal 339 may be provided to any of a peripheral device 336 and the robot control process 334. For example, in some embodiments, a logic output signal 339 is provided to a peripheral device 336, in some embodiments, a logic output signal 339 is provided to the robot control process 334, in some embodiments a single logic output signal 339 is provided to both a peripheral device 336 and the robot control process 334, and in some embodiments a logic output signal 339 is provided to a peripheral device 336 while another logic output signal 339 is provided to the robot control process 334.

In a next step M5 of the method, a robot arm 101 of the robot system 100 is controlled by the robot controller 110 by executing the robot control process 334 based on a robot control software program. Further, the robot controller 110 may at least partly control any of the peripheral device 336 and the robot arm 101 based on one or more logic output signals 339. In some embodiments a peripheral device 336 and the robot arm 101 is at least partly controlled based on the same logic output signal 339 or based on different logic output signals 339.

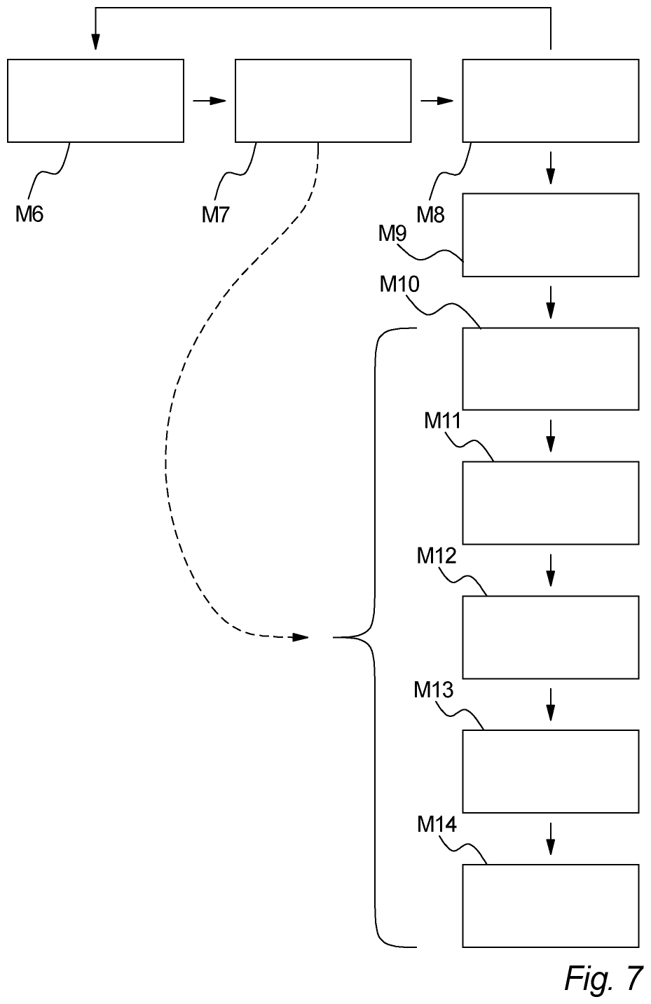

FIG. 7 illustrate a method according to some other embodiments of the invention. The method is for controlling operation of a robot system 100 at least partially based on a simulation of the robot system 100 and comprises nine steps M6-M14.

In a first step M6 of the method, robot and auxiliary control software code 546, 547 are provided. In some embodiments of the invention, this code 546, 547 is provided to the same programming/simulation device 543, e.g. a personal computer or a robot controller 110. In some embodiments of the invention, this code is configurable through a programming/simulation environment installed on the programming/simulation device 543, e.g. the code may be editable via a graphical user interface associated with the environment. Providing robot and auxiliary control software code 546, 547 may for example be understood as establishing the codes, importing the codes, editing codes, etc.

In a next step M7 of the method, a robot operation simulation 548 is performed. This simulation 548 emulates possible forthcoming steps M10-M14 of the method regarding operation of the robot system 100. The robot operation simulation 548 may for example comprise simulations of signals and signal processing, such as application input signals 338, logical signals 337, logical output signals 339 and processing of these. The robot operation simulation 548 may further comprise simulations of operations of the robot arm 101 and any peripheral devices 336, for example including durations of operations and interactions between signals, operations, application object 342, robot arm 101, robot tool 341, peripheral devices 336, robot control process 334, and auxiliary control process 335. The robot operation simulation 548 may additionally comprise simulations of the physical extend and motion of components of the robot system 100, e.g. the robot arm 101, peripheral devices 336, robot tool 341, and application object 342. As an output, the robot operation simulation 548 generates a simulation result 549, which is a representation of an output of the simulation, e.g. indicative of performance, duration, efficiency etc.

Hence, with one and the same simulation 548, both robot and auxiliary control software code 546, 547 can be simulated simultaneously. This means, that the effect of changes or additions to any one of the robot and auxiliary control software code 546, 547 can be simulated. Thereby unsuitable effects related to movement or safety of such software changes or additions, either alone or interrelated between the software 546, 547 can be found prior to approving the software for operating the robot arm 101.

In a next step M8 of the method, the simulation results 549 are evaluated. The simulation results may be evaluated manually by a user of the system or automatically by an automated evaluation algorithm. In some embodiments, the simulation results 549 are evaluated both based on automated evaluation and user interaction. The evaluation may for example include assessment of operation feasibility, assessment of duration of intended robot system operations, etc. If a user and/or an automated evaluation finds the simulation results 549 are indicative of an unsatisfactory performance of the robot system 100, new robot control software code and auxiliary control software code may be provided or updates can be made, i.e. the first step M6 of the method may be repeated, followed by a new simulation M7 and a new evaluation M8. In this way, providing code M6, performing simulations M7, and evaluating simulation results M8 is an iterative process which may be repeated until a satisfactory simulation result has been achieved. The iterative process may be partially of fully automated, or it may be partially or fully manual.

Whether a simulation result 549 is satisfactory or unsatisfactory may for example be based on user judgment, calculation of parameters indicative of the expected performance of the robot system based on the simulation, or evaluation of operation feasibility.

In a next step M9 of the method, the robot control software code 546 is compiled to a robot control software program 544 and the auxiliary control software code 547 is compiled to an auxiliary control software program 545. These programs 544, 545 are readable by the robot controller 110. The robot controller 110 may for example be a multi-core processor and the two programs 544, 545 may be used to execute to respective processes 334, 335 on two separate cores or groups of cores.

In some other embodiments of the invention, the simulation is performed based on the robot control software program 544 and the auxiliary control software program 545, and not based directly on the robot control software code 546 and the auxiliary control software code 547. In these embodiments, the simulation step M7 is performed prior to the compilation step M9. In some other embodiments, simulation is performed based on a combination of compiled and un-compiled code.

In a next step of the method M10, at least one application input signal 338 is transmitted to an auxiliary control process 335 of the robot controller 110 from any of a peripheral device 336 and the robot control process 334.

In a next step M11 of the method, one or more logic signals 337 are generated based on the at least one application input signal 338 by executing the auxiliary control process 335 based on the auxiliary control software program 545.

In a next step M12 of the method, at least one logic output signal 339 is established by executing the auxiliary control process 335. In this way, the at least one logic output signal 339 may be based on the one or more logic signals 337 established in the execution of the auxiliary control process 335.

In a next step M13 of the method, the at least one logic output signal 339 is provided to any of a peripheral device 336 and/or the robot control software code/program/process.

In a next step M14 of the method, a robot arm 101 of the robot system 100 is controlled by the robot controller 110 by executing the robot control process 334 based on the robot control software program 544. Further, the robot controller 110 controls any of the peripheral device 336 and the robot arm 101 based on the at least one logic output signal 339.

Hence the present invention relates to the use of a robot controller to execute auxiliary control software code taking up computational power from the robot controller which is needed for the heavy mathematical process of controlling a robot arm. However, by strategically performing carefully selected logic processing associated with a limited number of peripheral devices, it is possible to execute a robot control process and an auxiliary control process by the robot controller with a minimal impact of the ability for the robot controller to control movement of the robot controller. Accordingly, the invention may primarily be applicable in small and medium-sized robot applications, where a limited amount of computational power is required to execute the auxiliary control process. This is to allow the robot controller to simultaneously control robot arm movement and handling of the application object. However, note that the invention is not limited to any size or type of robot application, particularly due to the ever-increasing computational power of processers which may steadily broaden the robot application range of the invention in the future.

Note that, generally, any of the method steps of the invention may be performed automatically, for example via a computer or processor, such as the robot controller.

From the above, it is now clear that the invention relates to a robot system and a method for controlling a robot system. By strategically allocating resources of the robot controller 110 to perform signal processing of logical signals 337, 339, it is possible to reduce the need for auxiliary circuitry, such as external programmable logic circuits, to install a robot arm 101 in a robot application. This improved approach to facilitate the interaction between a robot arm 101 and its robot application further allows enhanced programming of the robot system, which in turn allows a straightforward simulation of the robot system 100 to evaluate and optimize a proposed operation of the system 100. Also the present invention enables to user to perform programming of the robot arm and the signal processing of logic signals in the same programming environment, consequently the user will easier be able to learn and implement both robot programming and signal logic programming of the entire robot system.

The invention has been exemplified above with the purpose of illustration rather than limitation with reference to specific examples of methods and robot systems. Details such as a specific method and system structures have been provided in order to understand embodiments of the invention. Note that detailed descriptions of well-known systems, devices, circuits, and methods have been omitted so as to not obscure the description of the invention with unnecessary details. It should be understood that the invention is not limited to the particular examples described above and a person skilled in the art can also implement the invention in other embodiments without these specific details. As such, the invention may be designed and altered in a multitude of varieties within the scope of the invention as specified in the claims.

BRIEF DESCRIPTION OF FIGUR REFERENCES

| | |
|---|---|
| 100 | robot system |
| 101 | robot arm |
| 102a-102f | robot joint |
| 103 | robot base |
| 104 | robot tool flange |
| 105a-105f | axis of robot joints |
| 106a-106f | rotation arrow of robot joints |
| 107 | robot tool flange reference point |
| 108 | robot base reference point |
| 109 | direction of gravity |
| 110 | robot controller |
| 111 | interface device |
| 112 | display |
| 113 | input devices |
| 114 | force torque sensor |
| 115 | acceleration sensor |
| 216a; 216b; 216f | output flange |
| 217a; 217b; 2179f | joint motors |
| 218a; 218B, 218f | output axle |
| 219a; 219b; 219f | joint sensor |
| 220a-220f | joint sensor signal |
| 221 | memory |
| 222 | processor |
| 223a, 223b, 223f | motor control signals |
| 224 | force signal |
| 225 | acceleration signal |
| 334 | robot control process |
| 335 | auxiliary control process |
| 336, 336a-336d | peripheral devices |
| 337 | logic signal |
| 338 | application input signal |
| 339 | logic output signal |
| 540 | graphical user interface |
| 341 | robot tool |
| 342 | application object |
| 543 | programming device |
| 544 | robot control software program |
| 545 | auxiliary control software program |
| 546 | robot control software code |
| 547 | auxiliary control software code |
| 548 | robot operation simulation |
| 549 | simulation results |
| 450 | logical operation |
| L1 | robot arm ready logic signal |
| L2 | peripheral camera logic signal |
| L3 | robot arm operation logic output signal |
| L4 | peripheral conveyer belt logic output signal |
| M1 | application input transmitted |
| M2 | generate logic signal |
| M3 | establish logic output signal |
| M4 | provide logic output signal to device or controller |
| M5 | control elements of robot system based at least |
| | partly on logic output signals |
| M6 | provide software code |
| M7 | perform robot operation simulation |
| M8 | evaluate simulation results |
| M9 | compile software code |
| M10 | transmit input signal |
| M11 | generate logic signal |
| M12 | establish logic output signal |
| M13 | provide logic output signal to device or controller |
| M14 | control element of the robot system based at least |
| | partly on logic output signals |

1. A system comprising:
a robotic arm comprising joints connecting a base and a tool flange;
a robot controller configured to execute processes comprising:
a robot control software program to implement a robot control process; and
an auxiliary control software program to implement an auxiliary control process; and
one or more peripheral devices communicatively connected to the robot controller;
wherein the robot control process causes operation of the robotic arm;
wherein the auxiliary control process is configured to produce one or more logic signals based on at least one application input signal received from at least one of the robot control process or the one or more peripheral devices; and
wherein the auxiliary control process is configured to produce, at least one logic output signal based on the one or more logic signals, and and is configured to control operation of at least one of the robot control process or the one or more peripheral devices based on the at least one logic output signal.

2. The system of claim 1, wherein the robot control process and the auxiliary control process are configured for parallel operation on the robot controller.

3. The system of claim 1, wherein the auxiliary control process is configured for continuous operation; and
wherein the auxiliary control process is configured to produce the at least one logic output signal within a program cycle in which the auxiliary control process is operated independently of a state of the at least one application input signal.

4. The system of claim 1, wherein the auxiliary control process is configured to execute sub-processes; and
wherein each of the sub-processes is configured to produce least one of the logic output signals.

5. The system of claim 4, wherein the auxiliary control process is configured to execute the sub-processes concurrently.

6. The system of claim 1, wherein the robot controller comprises a multi-core processor; and
wherein the robot control software program and the auxiliary control software program are executed on different cores of the multi-core processor.

7. The system of claim 1, wherein a logic output signal is based on logical operations applied to the one or more logic signals.

8. The system of claim 1, wherein the at least one logic output signal is output to operate a tool attached to the tool flange.

9. The system of claim 1, wherein the robot controller is configured to receive an application input signal from the tool.

10. The system of claim 1, wherein a peripheral device of the one or more peripheral devices is communicatively connected directly to the robot controller.

11. The system of claim 1, further comprising:
a programming device to provide the robot control software program and the auxiliary control software program.

12. The system of claim 11, wherein the programming device is configured to implement a simulation indicative of operation of the system based on execution of the robot control software program and the auxiliary control software program.

13. The system of claim 1, wherein at least one of the one or more peripheral devices is an output device.

14. The system of claim 1, wherein the one or more peripheral devices are configured for use during an operation cycle of the system.

15. The system of claim 1, wherein the system comprises at least one of:
the at least one application input signal is received from the one or more peripheral devices; or
the auxiliary control process is configured to control the one or more peripheral devices.

16. The system of claim 1, wherein the robotic arm is configured to operate based on the at least one logic output signal.

17. The system of claim 1, wherein the auxiliary control process is configured to control operation of the one or more peripheral devices based on the at least one logic output signal.

18. The system of claim 1, wherein the robot control process is configured to generate the at least one application input signal.

19. The system of claim 1, wherein the one or more peripheral devices are configured to generate the at least one application input signal.

20. The system of claim 1, wherein each of the one or more logic signals is indicative of a state of a peripheral device or the robot control process.

21. The system of claim 1, wherein the at least one logic output signal comprises a logic output signal that is the same signal as one of the one or more logic signals.

22. The system of claim 1, wherein the at least one logic output signal comprises a logic output signal that is based on logical operations applied to at least one of the logic signals.

23. The system of claim 1, wherein one of the logic signals is an application input signal.

24. The system of claim 1, wherein operation of the robotic arm comprises the robotic arm controlling the tool flange holding a tool to apply the tool to an object.

25. The system of claim 1, wherein a peripheral device of the one or more peripheral devices is in direct communication with the auxiliary control process.

26. The system of claim 1, wherein a peripheral device of the one or more peripheral devices is in direct communication with the auxiliary control software program.

27. The system of claim 1, wherein each peripheral device of the one or more peripheral devices is in direct communication with the robot controller.

28. The system of claim 1, wherein each peripheral device of the one or more peripheral devices is in direct communication with the auxiliary control process.

29. The system of claim 1, wherein each peripheral device of the one or more peripheral devices is in direct communication with the auxiliary control software program.

30. The system of claim 1, wherein the robot control software program comprises robot control software code that has been compiled.

31. The system of claim 30, wherein the auxiliary control software program comprises auxiliary control software code that has been compiled.

32. The system of claim 31, further comprising:
a programming device to provide the robot control software code and the auxiliary control software code;
wherein the programming device is programmed to enable configuration of the robot control software code and the auxiliary control software code.

33. The system of claim 32, wherein the programming device comprises a programming environment to configure the robot control software code and the auxiliary control software code.

34. The system of claim 32, wherein the programming device is configured to executed a simulation based on operation of the system, the simulation being based on the robot control software code and said the control software code.

35. The system of claim 32, wherein the programming device is configured to provide an evaluation of operation feasibility of the system based on the simulation; and
wherein the evaluation of operation feasibility is indicative of whether the system is able to operate as instructed by the robot control software code and the auxiliary control software code.

36. The system of claim 1, wherein a peripheral device of the one or more peripheral devices comprises a camera.

37. The system of claim 1, wherein a peripheral device of the one or more peripheral devices comprises a 3D (three dimensional) camera.

38. The system of claim 1, wherein a peripheral device of the one or more peripheral devices comprises a sensor.

39. The system of claim 1, wherein a peripheral device of the one or more peripheral devices comprises a conveyer belt.

40. The system of claim 1, wherein a peripheral device of the one or more peripheral devices comprises a peripheral display.

41. The system of claim 1, wherein a peripheral device of the one or more peripheral devices comprises an indication light.

42. The system of claim 1, wherein a peripheral device of the one or more peripheral devices comprises a valve.

43. The system of claim 1, wherein a peripheral device of the one or more peripheral devices comprises a user input mechanism,

44. The system of claim 1, wherein a peripheral device of the one or more peripheral devices comprises a mobile robot.

45. The system of claim 1, wherein a peripheral device of the one or more peripheral devices comprises an actuator.

46. The system of claim 1, wherein a peripheral device of said the or more peripheral devices comprises processing equipment, the processing equipment comprising at least one of a CNC (computer numerical control) machine, a pinching machine, or a molding machine.

47. The system of claim 1, wherein a peripheral device of the one or more peripheral devices comprises a PC (personal computer) or other type of computing device.

48. The system of claim 1, wherein a peripheral device of the one or more peripheral devices comprises an auxiliary robot system.

49. The system of claim 1, wherein the robot controller comprises a PLC (programmable logic circuit) software code import and translation module.

50. A method for controlling operation of a robot system, the method comprising:
providing at least one application input signal to an auxiliary control process implemented by executing an auxiliary control software program on a robot controller, the at least one application input signal being from at least one of a peripheral device in the robot system or a robot control process implemented by executing a robot control software program on the robot controller;
the auxiliary control process generating one or more logic signals based on the at least one application input signal;
the auxiliary control process producing at least one logic output signal based on the one or more logic signals;
providing the at least one logic output signal to the peripheral device or the robot control process; and and
the robot controller controlling a robotic arm in the robot system using the robot control process, wherein the robotic arm comprises joints connecting a base and a robot tool flange, and wherein the robot controller controls at least one of the peripheral device or the robotic arm based on the at least one logic output signal.

51. The method of claim 50, further comprising:
compiling robot control software code to produce the robot control software program.

52. The method of claim 51, further comprising:
compiling auxiliary control software code to produce auxiliary control software program.

53. The method of claim 52, wherein the robot control software code and the auxiliary control software code are produced using a programming environment on a programming device.

54. The method of claim 53, further comprising:
simulating at least one of the following operations: providing the at least one application input signal, the auxiliary control process generating the one or more logic signals, the auxiliary control process producing the at least one logic output signal, providing the at least one logic output signal, or the robot controller controlling the robotic arm;
wherein the simulating is performed on the programming device and is based on the robot control software code and the auxiliary control software code.

55. The method of claim 50, wherein the auxiliary control process producing the at least one logic output signal is is implemented by performing the auxiliary control process within a program cycle independently of a state of the at least one application input signal.

56. The method of claim 50, wherein the auxiliary control process producing the at least one logic output signal comprises executing sub-processes of the auxiliary control process, where each of the sub-processes is configured to produce at least one of the logic output signals.

57. The method of claim 56, wherein the sub-processes are executed concurrently.

58. The method of claim 50, wherein providing the at least one application input signal is performed during at least one of the auxiliary control process or the robot control process.

59. The method of claim 50, wherein providing the at least one application input signal is performed during operation of the robot system.

60. The method of claim 50, wherein providing the at least one application input signal is performed autonomously.

61. The method of claim 50, wherein the robot control process and the auxiliary control process are separate processes performed on the robot controller.

62. A pre-programmed computing system configured to perform the method of claim 50.

63. The method of claim 50, wherein the peripheral device interacts with an application object at least partially during at least one of the auxiliary control process or the robot control process.

64. The method of claim 54, further comprising:
evaluating an operation feasibility of the robot control software code and the auxiliary control software code, wherein the operation feasibility is based on the simulating.

65. The method of claim 64, wherein the operation feasibility is indicative of whether the robot system is able to operate as instructed by the robot control software code and the auxiliary control software code.

66. A method for controlling operation of a peripheral device of a system comprising a robotic arm, the method comprising:
providing at least one application input signal to an auxiliary control process of the system, the at least one application input signal being from at least one of a robot controller or one or more peripheral devices;
generating one or more logic signals based on the at least one application input signal by executing the auxiliary control process;
establishing, by the auxiliary control process, at least one output signal based on the one or more logic signals; and
providing the at least one output signal to a peripheral device of the one or more peripheral devices to control the peripheral device.

67. The method of claim 66, wherein the at least one output signal comprises at least one logic output signal.

68. The method of claim 66, wherein the robot controller controls the robotic arm by executing a robot control process.

69. The method of claim 66, wherein the system is a robotic system.

70. A distributed control system for a peripheral device of a robot system, wherein the robot system comprises a robotic arm, a controller, and a peripheral device, wherein the robotic arm comprises joints connecting a base and a tool flange, wherein the controller is at least configured to execute a robot control process to control operation of the robotic arm, and wherein the distributed control system comprises:
a first control block located in the robot controller; and
a second control block located outside the robot controller;
wherein the first control block and the second control block are configured to collectively control the peripheral device in coordination with the robot control process controlling the robotic arm, and wherein the coordination is implemented via a communicative connection between the robot control process and the first control block. cm 71. The distributed control system of claim 70, wherein the second control block is located in the peripheral device.

72. The distributed control system of claim 70, wherein the first control block and the second control block are located in separate casings.

73. The distributed control system of claim 70, wherein the first control block is configured to implement an auxiliary control process.

74. (canceled)

75. A peripheral device controller configured to execute processes comprising:
a robot control process based on a robot control software program; and
an auxiliary control process based on an auxiliary control software program;
wherein execution of the robot control process causes operation of a robotic arm communicatively connected to the peripheral device controller;
wherein execution of the auxiliary control process produces one or more logic signals based on at least one application input signal received from at least one of the robot control process or one or more peripheral devices; and
wherein the auxiliary control process is configured to establish at least one logic output signal based on the one or more logic signals, and is configured to control operation of at least one of the robot control process or the one or more peripheral devices based on said at least one logic output signal.

76. (canceled)
